(19) United States
(12) Patent Application Publication
(10) Pub. No.: US 2013/0335428 A1
(43) Pub. Date: Dec. 19, 2013

(54) METHOD FOR AUTOMATIC DISPLAY OF SPREAD IN EBOOK

(71) Applicant: YINGQIDA INFORMATION CO., LTD., NEW TAIPEI CITY (TW)

(72) Inventors: HAI-TAO WO, SHANGHAI CITY (CN); PEI-HSUN TSAI, NEW TAIPEI CITY (TW); KUANG-WEI WANG, NEW TAIPEI CITY (TW); KAMIYAMA HIROSHI, NEW TAIPEI CITY (TW)

(73) Assignee: YINGQIDA INFORMATION CO., LTD., NEW TAIPEI CITY (TW)

(21) Appl. No.: 13/684,294

(22) Filed: Nov. 23, 2012

(30) Foreign Application Priority Data
Jun. 18, 2012 (TW) 101121825

(51) Int. Cl. G06T 1/00

(52) U.S. Cl. CPC G06T 1/0007
USPC 345/501

(57) ABSTRACT

A method for automatic display of a spread in ebooks is revealed. The method includes several steps. First scan at least one paper book by a scanner to get at least one original page file with at least two original pages. Then execute a transcription suite in a computing device for transcribing the original page file into an e-book and write at least one spread event into at least one electronic page of the e-book by an input device. Next use a reader to read the e-book. The reader triggers the spread event while reading the electronic page written with the spread event. Thus the reader automatically retrieves and displays at least two electronic pages on a monitor of the reader simultaneously. Therefore the spread covering at least two electronic pages is automatically displayed on a monitor of the reader.

### BACKGROUND OF THE INVENTION

1. Fields of the Invention

The present invention relates to a method for automatic display of a spread in ebooks, especially to a method for automatic display of a spread in ebooks in which at least one spread event is written into at least one electronic page so that the spread covering at least two pages in ebooks can be automatically displayed.

2. Descriptions of Related Art

In recent years, electronic devices such as desktop computers, notebooks, tablets, smart phones, personal digital assistant (PDA), etc. are increasingly becoming a common part of our lives. Consumers are getting used to read electronic figures and words. With the fast development of internet and prevalence of cloud services, figures and documents saved or delivered in the electronic form have become a mainstream. Moreover, paperless or electronic documents have become a new trend for energy saving, carbon. reduction and environmental protection. Thus e-book industry is an emerging industry with prosperous development. Now there are a lot of large-scale online bookstores that not only sell paper books but also books in digital form. All these show growing demand for ebooks.

For convenient display on a monitor of the electronic device, most of ebooks are shown in a single-page format. The e-book brings up one page at a time. However, some ebooks are acquired by scanning of paper books. The center spread (spread layout) or pullout originally in the paper book is unable to be displayed. This causes readers inconvenience in reading.

Thus there is room for improvement and a need to provide a novel method for automatic display of a spread in ebooks. Firstly, get at least one original page file with at least two original pages by using a scanner to scan at least one paper book. Then execute a transcription suite in a computing device for transcribing the original page file into an e-book and write at least one spread event into at least one electronic page of the e-book through the transcription suite. Next use a reader to read the e-book. The reader triggers the spread event while reading the electronic page with the spread event and automatically retrieves at least two electronic pages.

Thus the electronic pages are shown on a monitor of the reader simultaneously. Therefore the spread covering several pages is automatically recognized and shown on the monitor of the reader. Moreover, the spread event can be set to be triggered only in a spread mode according to reading habits of different users. While in a single-page mode, the spread event is skipped. Thus the reader only retrieves and displays a single electronic page on the monitor.

Furthermore, the transcription suite can also write a cover event, a back cover event or a contents page event into the electronic page so that the reader recognizes or triggers these events for providing specific functions corresponding to the cover, the back cover and the contents page. For convenience of input of the e-book transcribed from the original page file written with the cover event, the back cover event and the contents page event, the transcription suite includes a virtual printer that outputs ebooks with the cover, the back cover, the contents page and the spread function by virtual printing. Thus the original page file without automatic display of the spread is transcribed into an e-book format with automatic display of the spread.

### SUMMARY OF THE INVENTION

Therefore it is a primary object of the present invention to provide a method for automatic display of a spread in ebooks that adds at least one spread event that can be triggered by a reader in an e-book. Once the spread event is triggered by the reader, the reader automatically retrieves and displays at least two electronic pages simultaneously. Thus a spread covering at least two electronic pages is shown on a single monitor.

It is another object of the present invention to provide a method for automatic display of a spread in ebooks in which at least one original page file with at least two original pages is transcribed into an e-book having at least one spread event. Thus the original page file without automatic display of the spread is converted into an e-book format with automatic display of the spread.

It is a further object of the present invention to provide a method for automatic display of a spread in ebooks in which at least one electronic page is written with a cover event, a back cover event or a contents page event by using a transcription suite. Thus a reader provides specific functions corresponding to the cover, the back cover or the contents page while reading the electronic page.

In order to achieve the above objects, a method for automatic display of a spread in ebooks of the present invention includes following steps. First acquire at least one original page file having at least two original pages and save the original page file in a memory device. Then execute a transcription suite in a computing device for transcribing the original page file into an e-book and write at least one spread event into at least one electronic page of the e-book by an input device. The e-book is also stored in the memory device. Next use a reader to read the e-book. The reader triggers the spread event while reading the electronic page written with the spread event. Thus the reader automatically retrieves and displays at least two electronic pages on a monitor of the reader simultaneously.

The original page file is acquired by using a scanner to scan at least one paper book and having at least two original pages. The original page file can be a pdf file or an image file in format of bmp, jpg, tif, png, gif, etc. The transcription suite can be executed in a computing device such as a tablet computer, a notebook or a desktop computer. The transcription suite also includes a virtual printer program for transcribing the original page file into the e-book having at least one electronic pages and at least one spread event by virtual printing. In the transcription of the virtual printer, the output format can be selected and the spread event is maintained. After being written with the spread event and transcribed by the transcription suite, the original page file originally without automatic display of the spread acquires the function of automatic display of the spread

Moreover, the at least one electronic page of the e-book is written with a cover event, a back cover event or a contents page event through the transcription suite. After recognizing or triggering these events, the reader can automatically display a miniature of the electronic page with the cover event in an interface for selecting ebooks, go back to the electronic page with the contents page event during the reading of the e-book, or show a finished message while getting the electronic page with the back cover event.

Furthermore, the spread event can be set to be triggered only in a spread mode. While in a single-page mode, the spread event is skipped so that the reader only retrieves and shows an electronic page on the monitor. Thus requirements of different users with various reading habits are satisfied.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a flow chart showing steps of an embodiment according to the present invention;

FIG. 2 is a schematic drawing showing component relationships of an embodiment according to the present invention; and

FIG. 3 is a schematic drawing showing component relationships of another embodiment according to the present invention.

### DETAILED DESCRIPTION OF THE PREFERRED EMBODIMENT

A method for automatic display of a spread in ebooks of the present invention features on that at least one original page file that contains at least two original (parent) pages is transcribed into an e-book that contains at least one spread event. The e-book is added with at least one spread event triggered by a reader. While the spread event being triggered by the reader, at least two electronic pages are automatically retrieved and displayed simultaneously. By the present invention, the spread event is contained in a format of the e-book. And the reader reads and triggers the spread event so as to retrieve at least two electronic pages at the same time and display these electronic pages on a monitor of the reader.

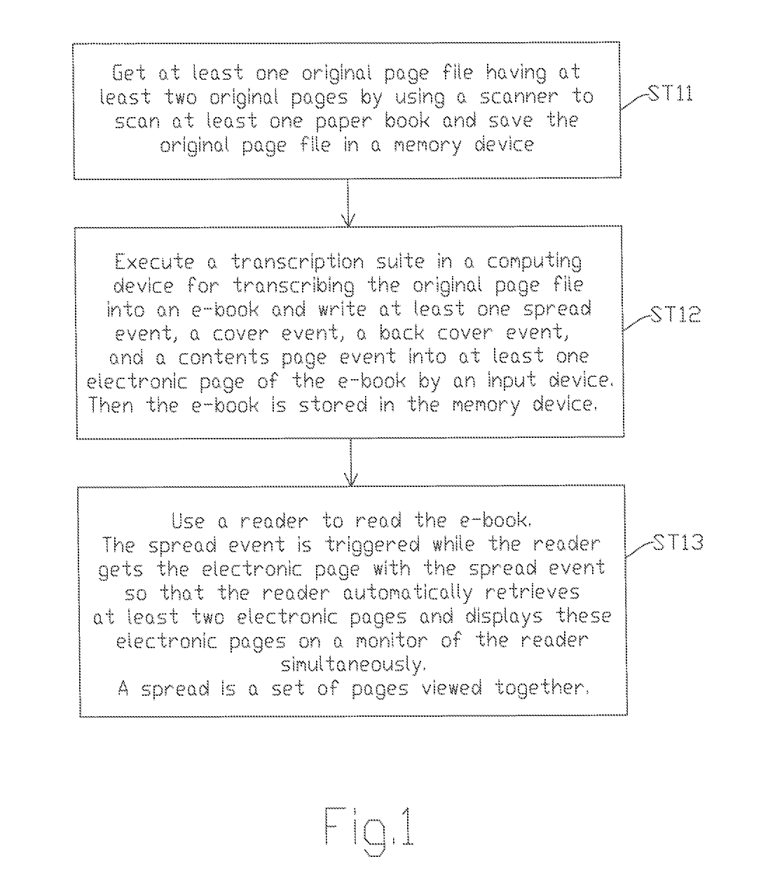

Refer to FIG. 1, a method for automatic display of a spread in ebooks of the present invention includes following steps:

ST1: Get at least one original page file having at least two original pages by using a scanner to scan at least one paper book and save the original page file in a memory device.
ST2: Execute a transcription suite in a computing device for transcribing the original page file into an e-book and write at least one spread event, a cover event, a back cover event, and a contents page event into at least one electronic page of the e-book by an input device. Then the e-book is stored in the memory device.
ST3: Use a reader to read the e-book. The spread event is triggered while the reader gets the electronic page with the spread event so that the reader automatically retrieves at least two electronic pages and displays these electronic pages on a monitor of the reader simultaneously. A spread is a set of pages viewed together.

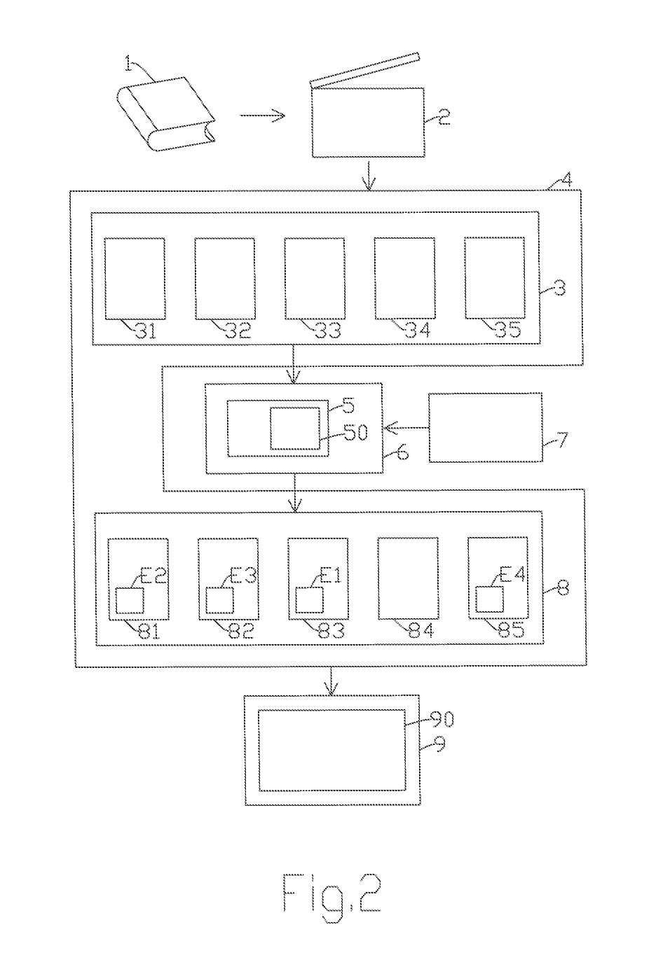

As shown in FIG. 2, a paper book 1 is scanned by a scanner 2 to get an original page file 3. The original page file 3 is a pdf file and having five original pages-a first original page 31, a second original page 32, a third original page 33, a fourth original page 34, and a fifth original page 35. The original page file 3 is saved in a memory device 4. A transcription suite 5 is executed in a computing device 6. Perform virtual printing of the original page file 3 by means of a virtual printer program 50 contained in the transcription suite 5 to produce an e-book 8. The e-book 8 includes a first electronic page 81, a second electronic page 82, a third electronic page 83, a fourth electronic page 84, and a fifth electronic page 85. Moreover, a spread event E1 is written into the third electronic page 83 by an input device 7. In a similar way, a cover event E2 is written into the first electronic page 81, a contents page event E3 is written into the second electronic page 82, and a back cover event E4 is written into the fifth electronic page 85. The e-book 8 is stored in the memory device 4.

A reader 9 is used to retrieve the e-book 8 and it will trigger the spread event E1 while reading the third electronic page 83 with the spread event E1. Thus the reader 9 retrieve the third electronic page 83 and the fourth electronic page 84 automatically and display the third electronic page 83 and the fourth electronic page 84 at the same time on a monitor 90 thereof. Moreover, in an interface for selecting ebooks, the reader 9 recognizes the cover event E2 of the e-book 8 and retrieves a miniature of the first electronic page 81 automatically so as to display the miniature together with miniatures of electronic pages written with the cover events in other ebooks for users to select one of the ebooks. While reading the e-book 8, the reader 9 also provides a function of going back to contents page all the time. When the user inputs a command for going back to the contents page, the reader 9 calls and recognizes the contents page event E3 so as to display the second electronic page 82 on the monitor 90. The reader 9 also triggers the back cover event E4 while reading the fifth electronic page 85 and a reminder message “the last page” is shown. When the user clicks again, the reading of the e-book 8 is stopped automatically and the reader 9 goes back to the interface for selecting ebooks.

When the original page file 3 is transcribed into the e-book 8 by the transcription suite 5, the spread event E1 is written into the third original page 33. The reader 9 triggers the spread event E1, reads the third original page 33 and the fourth original page 34 automatically and displays both the third original page 33 and the fourth original page 34 simultaneously on the monitor 90 when the reader 9 gets the spread event E1. Thus the original page file 3 automatic display of the spread is converted to the e-book 8 with automatic display of the spread. Moreover, the reader 9 can recognize the spread event E1 automatically and display the spread. The cover event E2, the back cover event E4 and the contents page event E3 can also be recognized or triggered by the reader 9 so as to make the reader 9 provide specific functions corresponding to the cover, the back cover and the contents.

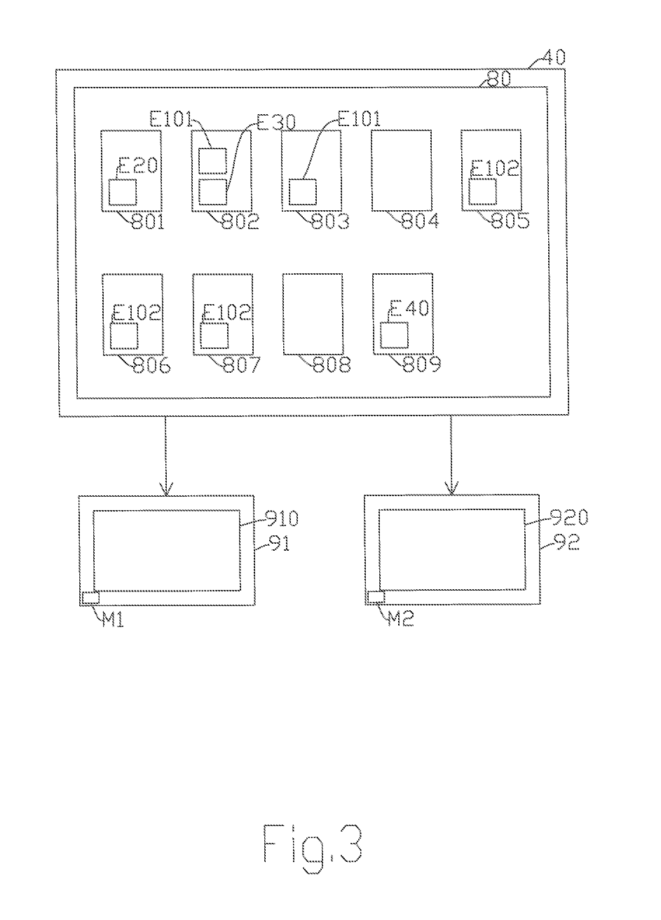

Refer to FIG. 3, a schematic drawing showing component relationships of another embodiment according to the present invention is revealed. As shown in the figure, an e-book 80 is saved in a memory device 40 and is including nine electronic pages-a first electronic page 801, a second electronic page 802, a third electronic page 803, a fourth electronic page 804, a fifth electronic page 805, a sixth electronic page 806, a seventh electronic page 807, an eighth electronic page 808, and a ninth electronic page 809. The first electronic page 801 is written with a cover event E20 and a contents page event E30 is written to the second electronic page 802. The second electronic page 802 and the third electronic page 803 are respectively written with a first spread event E101. The fifth electronic page 805, the sixth electronic page 806, and the seventh electronic page 807 are respectively written with a second spread event E102. A back cover event E40 is written to the ninth electronic page 809.

When a reader 91 set in a spread mode M1 is used to read the e-book 80, the reader 91 recognizes the cover event E20 of the e-book 80 in an interface for selecting ebooks so as to automatically retrieve and display a miniature of the first electronic page 801. The miniature of the first electronic page 801 is shown on the interface for selecting ebooks together with miniatures of electronic pages written with cover events in other ebooks for users to select one of the ebooks. After the user inputting a command for going back to contents page while reading the e-book 80, the reader 91 calls and recognizes the contents page event E30 and the second electronic page 802 is displayed on a monitor 910 of the reader 91. At this moment, the reader 91 also triggers the first spread event E101 written in the second electronic page 802 and automatically reads the second electronic page 802 and the third electronic page 803. Then both the second electronic page 802 and the third electronic page 803 are shown on the monitor 910. No matter the user reads the e-book 80 page by page or skips to the page he selects, the reader 91 triggers the first spread event E101 while getting the second electronic page 802/or the third electronic page 803 with the first spread event E101. Thus the reader 91 automatically retrieves and displays both the second electronic page 802 and the third electronic page 803 on the monitor 910 simultaneously. When the user reads the e-book 80 page by page or skips to the page he selects and the reader 91 gets the fifth electronic page 805, the sixth electronic page 806, or the seventh electronic page 807 with the second spread event E102, the second spread event E102 is triggered so that the reader 91 automatically retrieves and displays the fifth electronic page 805, the sixth electronic page 806, and the seventh electronic page 807 on the monitor 901 simultaneously. When the reader 91 reads the ninth electronic page 809, the back cover event E40 is triggered and a reminder message “the last page” is shown. While the user clicks again, the reading of the e-book 80 is finished and the reader 91 goes back to the interface for selecting ebooks.

While using a reader 92 set in a single-page mode M2 to read the e-book 80, the reader 92 doesn't recognize the first spread event E101 and the second spread event E102. Thus the first spread event E101 will not be triggered when the reader 92 gets the second electronic page 802 or the third electronic page 803. And only the second electronic page 802 or the third electronic page 803 is shown on a monitor 92 of the reader 92. The user needs to input a page forward command or a page back command to show the third electronic page 803 or the second electronic page 802. Similarly, the second spread event E102 will not be triggered when the reader 92 gets the fifth electronic page 805, the sixth electronic page 806 or the seventh electronic page 807. Thus only the fifth electronic page 805, the sixth electronic page 806 or the seventh electronic page 807 is displayed on the monitor 920. The user needs to input the page forward command or the page back command once or twice to show other electronic pages 805-807. Moreover, the reader 92 can still recognize the cover event E20 of the e-book 80 in the interface for selecting ebooks while reading the e-book 80, automatically retrieve and display a miniature of the first electronic page 801. When a command of back to contents page is input by the user, the reader 92 automatically calls the contents page event E30 and shows the second electronic page 802. While reading the ninth electronic page 809, the back cover event E40 is triggered to show a reminder message “the last page”. The reader stops reading of the e-book 80 by clicking again and the reader 91 goes back to the interface for selecting ebooks

Thus the reader 91/or 92 can be set in the spread mode M1 or the single-page mode M2. In the spread mode M1, the first spread event E101 or the second spread event E102 can be triggered normally. Thus both the second electronic page 802 and the third electronic page 803, or the fifth electronic page 805, the sixth electronic page 806, and the seventh electronic page 807 are retrieved automatically and displayed simultaneously on the monitor 910. In the single-page mode M2, the reader 92 automatically skips the first spread event E101 or the second spread event E102. Thus only a single electronic page such as the second electronic page 802, the third electronic page 803, the fifth electronic page 805, the sixth electronic page 806, or the seventh electronic page 807 is shown on the monitor 920 while the reader 92 reading the second electronic page 802, the third electronic page 803, the fifth electronic page 805, the sixth electronic page 806, or the seventh electronic page 807. The requirements of different users with various reading habits can be satisfied by switching between the spread mode M1 and the single-page mode M2.

In summary, a method for automatic display of a spread in ebooks of the present invention includes a plurality of steps. First of all, scan at least one paper book by a scanner to get at least one original page file having at least two original pages. Then execute a transcription suite for transcribing the original page file into an e-book and write at least one spread event into at least one electronic page of the e-book through the transcription suite. Next use a reader to read the e-book. The spread event is triggered by the reader while the reader gets the electronic page written with the spread event. Thus the reader automatically retrieves and displays at least two electronic pages on a monitor of the reader simultaneously. By the present invention, the original page file without automatic display of the spread is transcribed into the e-book with automatic display of the spread. Moreover, the spread event is triggered and the spread is automatically displayed when the reader reads the e-book. Furthermore, at least one electronic page of the e-book can also be written with a cover event, a back cover event or a contents page event through the transcription suite so that the reader provides specific functions of the cover, the back cover or the contents page according to the cover event, the back cover event or the contents page event. In addition, for meeting requirements of different users with various reading habits, the spread event can be set to be triggered only in the spread mode while the reader skips the spread event in the single-page mode so that the reader reads and displays only a single electronic page on the monitor.

Additional advantages and modifications will readily occur to those skilled in the art. Therefore, the invention in its broader aspects is not limited to the specific details, and representative devices shown and described herein. Accordingly, various modifications may be made without departing from the spirit or scope of the general inventive concept as defined by the appended claims and their equivalents.

What is claimed is:

1. A method for automatic display of a spread in electronic books comprising the steps of:
acquiring an electronic book having at least two electronic pages, writing at least one spread event into at least one electronic page of the electronic book by an input device, and storing the electronic book in a memory device; and
using a reader to read the electronic book;
wherein the reader triggers the spread event while getting the electronic page written with the spread event; thus the reader automatically reads and simultaneously displays at least two electronic pages on a monitor of the reader.

2. The method as claimed in claim 1, wherein the electronic book is acquired by executing a transcription suite in a computing device to transcribe at least one original page file having at least two original pages into the electronic book.

3. The method as claimed in claim 2, wherein the original page file is obtained by using a scanner to scan at least one paper book.

4. The method as claimed in claim 2, wherein the original page file is a pdf file.

5. The method as claimed in claim 2, wherein the original page file is an image file in format of bmp, jpg, tif, png, or gif.

6. The method as claimed in claim 2, wherein the computing device is a tablet computer, a notebook computer or a desktop computer.

7. The method as claimed in claim 2, wherein the transcription suite includes a virtual printer program that transcribes the original page file into the electronic book having the spread event by virtual printing.

8. The method as claimed in claim 1, wherein at least one electronic page of the electronic book is written with a cover event, a back cover event or a contents page event by the input device.

9. The method as claimed in claim 1, wherein the readers includes a spread mode and a single-page mode; in the spread mode, the reader triggers the spread event and thus automatically reads and simultaneously displays at least two electronic pages; in the single-page mode, the reader skips the spread event and thus reads and displays only one electronic page on the monitor.

10. The method as claimed in claim 1, wherein the spread event is written into at least two electronic pages related to the spread event so that the reader automatically reads and simultaneously displays the electronic pages on the monitor thereof while getting one of the electronic pages written with the spread event.
